(19) United States
(12) Patent Application Publication
(10) Pub. No.: US 2009/0210500 A1
(43) Pub. Date: Aug. 20, 2009

(54) SYSTEM, COMPUTER PROGRAM PRODUCT AND METHOD OF ENABLING INTERNET SERVICE PROVIDERS TO SYNERGISTICALLY IDENTIFY AND CONTROL SPAM E-MAIL

(76) Inventors: David Clark Brillhart, Orlando, FL (US); Christopher James Dawson, Arlington, VA (US); Rick Allen Hamilton, II, Charlottesville, VA (US); Michael David Kendzierski, New York, NY (US); James Wesley Seaman, Falls Church, VA (US)

Correspondence Address: IBM CORPORATION;INTELLECTUAL PROPERTY LAW, 11501 BURNET ROAD, AUSTIN, TX, 78758, US

(21) Appl. No.: 12/034,189

(22) Filed: Feb. 20, 2008

(51) Int. Cl. G06F 15/82

(52) U.S. Cl. 709/206

(57) ABSTRACT

Presently, when an e-mail message is identified as SPAM, it is deleted and the process ends. According to the system, computer program product and method provided herein, upon identifying an e-mail message as SPAM, source information, identity and data stream of the e-mail message are transferred to a database accessible by trusted ISPs. The trusted ISPs may compare the transferred data stream to data stream of incoming and outgoing e-mail messages to determine whether they are also SPAM and the transferred source information and identity may be used to determine an original sender (i.e., a spammer) of the message.

### BACKGROUND OF THE INVENTION

1. Technical Field

The present invention is generally directed to electronic messaging systems. More specifically, the present invention is directed toward a system, computer program product and method of enabling Internet service providers (ISPs) to synergistically identify and control SPAM e-mail.

2. Description of Related Art

Electronic messaging, such as electronic mail (e-mail), is increasingly is being used to distribute unwanted advertisements (i.e., SPAM) to network users. This, in turn, forces network providers (i.e., ISPs, employers etc.) to provide greater and greater transmission bandwidth to accommodate the SPAM e-mail messages as well as ever-increasing storage space to store them. Further, as SPAM e-mail increases, network users waste more and more time identifying the SPAM e-mail messages from regular e-mail messages in order to discard them. Thus, SPAM e-mail places a burden on storage, network, email systems and network users. Consequently, a plurality of different methods is currently being used to control SPAM e-mail.

One method being used to control SPAM e-mail uses some sort of filtering measures to control SPAM e-mail. As one example, most e-mail application programs allow users to filter out of their in-boxes specific e-mail messages. This can generally be done as follows: after receiving a SPAM e-mail message, a user can set the filter features in the e-mail program to send further incoming e-mail messages from the sender (or spammer) directly to a bulk or deleted box instead of to the user's in-box.

Other examples of filtering measures that may be used include: real-time blackhole list (RBL), domain name system blacklist (DNSBL), uniform resource identifier blacklist (URIBL), right-hand side blacklist (RHSBL), dynamic realtime block list (DynRBL) and domain name system whitelist (DNSWL).

In RBL, an Internet Website publishes a list of Internet protocol (IP) addresses generally associated with spammers in a format which can be easily queried by computer programs on the Internet. Mail servers are then configured to reject or flag messages which have been sent from a site listed on one or more such lists as SPAM e-mail messages.

RBL is proprietary. However, domain name system blacklist (DNSBL) and distributed realtime block list (DRBL), which are based on the same principle as RBL, are freely available.

RHSBL is similar to RBL. However, RHSBL lists domain names instead of IP addresses. Therefore, clients check the “right-hand side” of an email address (i.e., the part after the @ sign of an e-mail address) and thus the term RHSBL.

Just as in the case of RHSBL, URIBL lists domain names. However, URIBL also lists IP addresses that appear in uniform resource identifiers (URIs) such as Websites mentioned in message bodies. By contrast, RHSBL lists domain names used in e-mail addresses.

DynRBL is similar to DRBL. However, DynRBL not only grows with new information, but also expires entries, to therefore maintain a current list.

DNSWL lists IP addresses that some users may want to treat more favorably than IP addresses. For example, DNSWL provides a Whitelist of known legitimate e-mail servers to reduce the chances of false positives while SPAM filtering. DNSWL effectively divided the entire Internet up into five trust levels: high (never sends SPAM), medium (extremely rare SPAM occurrences and corrected promptly), low (occasional SPAM occurrences, actively corrected but less promptly) and none (legitimate mail server, may also send SPAM).

Another filtering measure in use is Bayesian e-mail filters. Bayesian e-mail filters take advantage of Bayes' theorem, which says that the probability that an email is SPAM, given that it has certain words in it, is equal to the probability of finding those certain words in SPAM email, times the probability that any email is SPAM, divided by the probability of finding those words in any email (i.e., Pr(SPAM/words)=[Pr(words/SPAM)*Pr(SPAM)]÷[Pr(words)]. However, to decrease the efficacity of Bayesian filters, Spammers insert random innocuous words that are not normally associated with SPAM.

A yet other filtering measure is procmail. Procmail is a mail filter that processes incoming e-mails on a Unix computer system. Common operations carried out with procmail include filtering and sorting of e-mails into different folders according to keywords in the “from, to, subject, text of the e-mail message.” A common practice is to let procmail call an external SPAM filter program, such as SPAMAssassin to automatically delete the message. SPAMAssassin is an extensible e-mail filter that is used to identify SPAM. SPAMAssassin uses a complex point system to determine whether an email should be accepted or rejected. Instead of allowing or denying a piece of mail based on one rule, SPAMAssassin allows a user to set the point value at which mail will be dropped. This allows a system administrator to tweak the configuration easily depending on how many false positives are reported.

Another method that can be used to control SPAM e-mail is to report a spammer to the spammer's ISP. Many commercial ISPs forbid users from using the ISPs' services to disseminate SPAM e-mail. Thus, if an ISP is made aware of a user who is using the ISP's services to send out SPAM e-mail messages, the ISP may ban the user from continuing to use the ISP's services.

Spammers are aware of all the different filtering measures available to users and thus generally do not send SPAM e-mail messages directly from their ISPs to recipients' ISPs. Instead, spammers channel SPAM e-mail messages through different, ever-changing ISPs. Doing so not only frustrates the filtering features available to network users but also obfuscates the origin of the messages.

Nonetheless, each computer system that handles an e-mail message generally adds a “received” line to a header of the message. Thus, to report a spammer to the spammer's ISP, a user needs to track down the original ISP of the message by displaying the header of the message. By scrutinizing the “received” lines in the displayed header, and working from top to bottom, the user can generally determine the origin of the SPAM e-mail message.

But note that none of the methods listed above allows for a concerted effort among ISPs to identify and control SPAM e-mail.

Thus, what is needed is a system, computer program product and method of enabling ISPs to synergistically identify and control SPAM e-mail.

### SUMMARY OF THE INVENTION

The present invention provides a system, computer program product and method of enabling Internet service providers (ISPs) to synergistically identify and control SPAM electronic mail (e-mail) messages on a network. Presently, when an e-mail message is identified as SPAM, it is deleted and the process ends. According to the invention, upon identifying an e-mail as SPAM, source information, identity and data stream of the e-mail message is transferred to a database of SPAM e-mail messages before deleting the SPAM e-mail message. The database is accessible to trusted ISPs that may use the transferred data stream to determine whether incoming and outgoing e-mail messages are also SPAM e-mail messages. The trusted ISPs may also use to the transferred identity and source information to determine whether the identified originally comes from a user that is being service by the ISPs. If so, proper actions may be taken to stop the user from continuing to disseminate SPAM using the ISPs' services.

### BRIEF DESCRIPTION OF THE DRAWINGS

The novel features believed characteristic of the invention are set forth in the appended claims. The invention itself, however, as well as a preferred mode of use, further objectives and advantages thereof will best be understood by reference to the following detailed description of an illustrative embodiment when read in conjunction with the accompanying drawings, wherein:

FIG. 1 depicts a pictorial representation of a network of data processing systems in which the present invention may be implemented.

FIG. 2 is a block diagram of a data processing system that may be implemented as a mail server.

FIG. 3 is a block diagram illustrating a data processing system is depicted in which the present invention may be implemented.

FIG. 4 is an exemplary mail system infrastructure.

FIG. 5 is a flowchart of a process that may be used by a trusted ISP that identifies a SPAM e-mail message.

FIG. 6 is a flowchart of a process that may be used by a clearinghouse upon receiving a SPAM e-mail id of a SPAM e-mail message.

FIG. 7 is a flowchart of a process that may be used by a trusted ISP when receiving SPAM e-mail id(s) from a clearinghouse.

### DETAILED DESCRIPTION OF THE PREFERRED EMBODIMENT

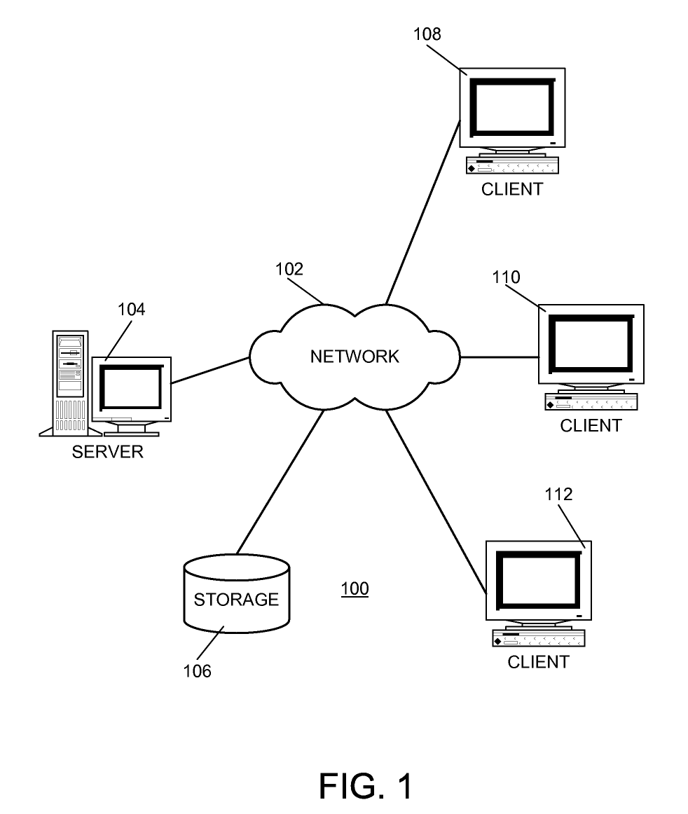

With reference now to the figures, FIG. 1 depicts a pictorial representation of a network of data processing systems in which the present invention may be implemented. Network data processing system 100 contains a network 102, which is the medium used to provide communications links between various devices and computers connected together within network data processing system 100. Network 102 may include connections, such as wire, wireless communication links, or fiber optic cables.

In the depicted example, server 104 is connected to network 102 along with storage unit 106. In addition, clients 108, 110, and 112 are connected to network 102. These clients 108, 110, and 112 may be, for example, personal computers or network computers. In the depicted example, server 104 may provide data, such as boot files, operating system images, e-mail messages and applications to clients 108, 110 and 112. Clients 108, 110 and 112 are clients to server 104. Network data processing system 100 may include additional servers, clients, and other devices not shown. In the depicted example, network data processing system 100 is the Internet with network 102 representing a worldwide collection of networks and gateways that use the transmission control protocol/Internet protocol (TCP/IP) suite of protocols to communicate with one another. At the heart of the Internet is a backbone of high-speed data communication lines between major nodes or host computers, consisting of thousands of commercial, government, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the present invention.

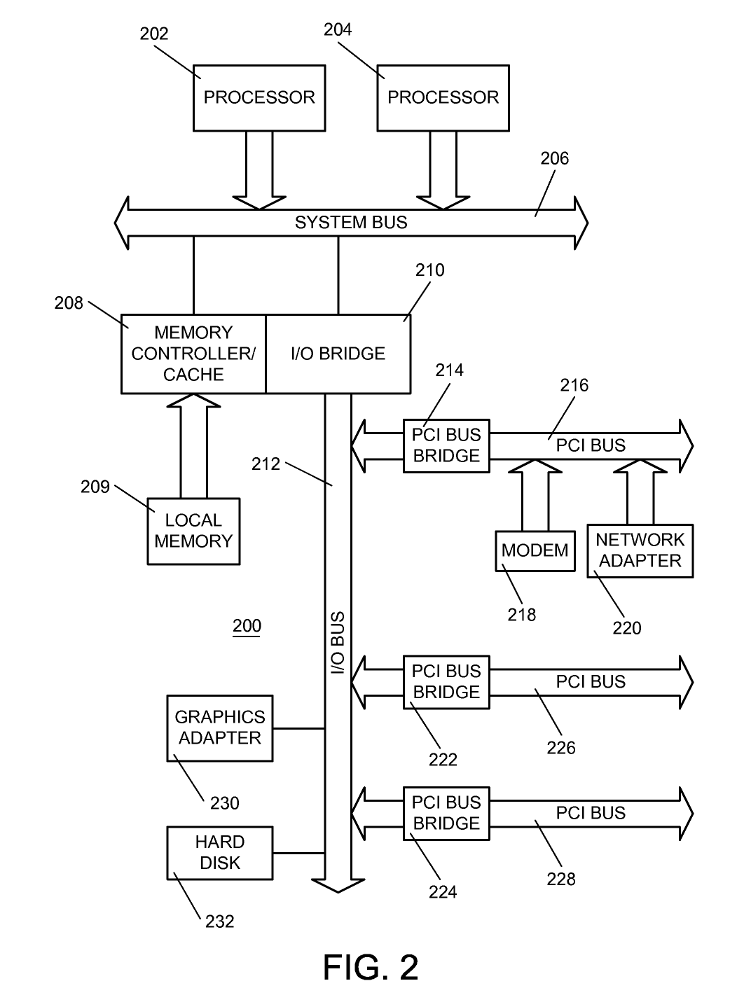

Referring to FIG. 2, a block diagram of a data processing system that may be implemented as a mail server, such as server 104 in FIG. 1, is depicted in accordance with a preferred embodiment of the present invention. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. Input/output (I/O) bus bridge 210 is connected to system bus 206 and provides an interface to I/O bus 212. Memory controller/cache 208 and I/O bus bridge 210 may be integrated as depicted.

Peripheral component interconnect (PCI) bus bridge 214 connected to I/O bus 212 provides an interface to PCI local bus 216. A number of modems may be connected to PCI local bus 216. Typical PCI bus implementations will support four PCI expansion slots or add-in connectors. Communications links to network computers 108, 110 and 112 in FIG. 1 may be provided through modem 218 and network adapter 220 connected to PCI local bus 216 through add-in boards. Additional PCI bus bridges 222 and 224 provide interfaces for additional PCI local buses 226 and 228, from which additional modems or network adapters may be supported. In this manner, data processing system 200 allows connections to multiple network computers. A memory-mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 2 may be, for example, an IBM e-Server pSeries system, a product of International Business Machines Corporation in Armonk, N.Y., running the Advanced Interactive Executive (AIX) or LINUX operating system (OS).

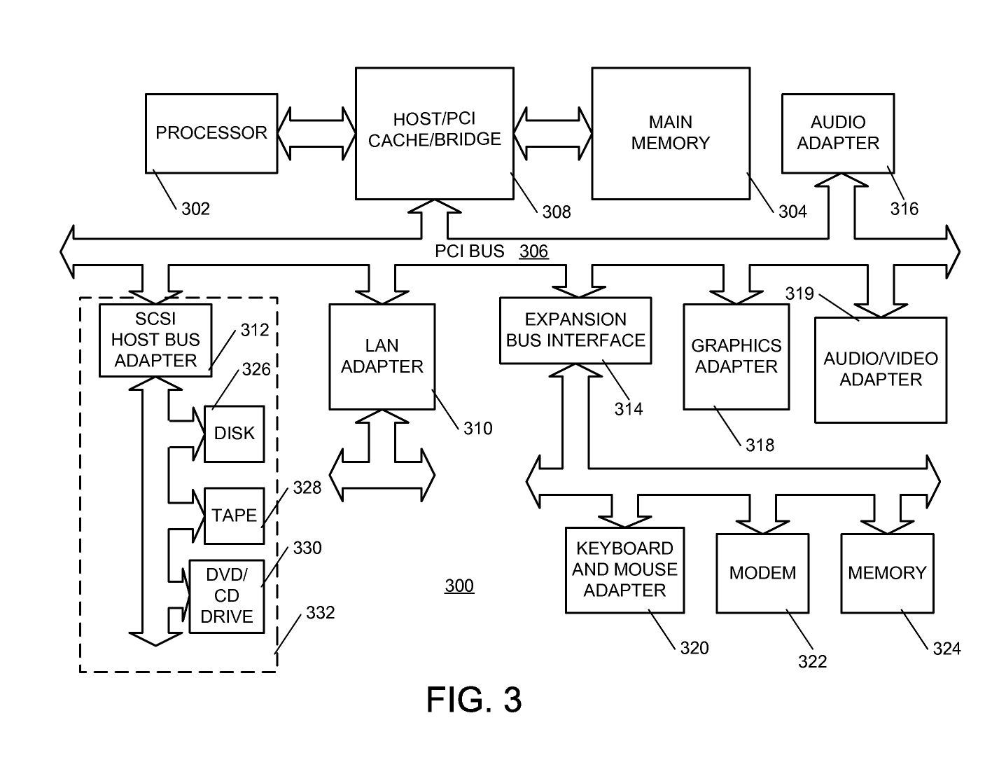

With reference now to FIG. 3, a block diagram illustrating a data processing system is depicted in which the present invention may be implemented. Data processing system 300 is an example of a client computer. Data processing system 300 employs a PCI local bus architecture. Although the depicted example employs a PCI bus, other bus architectures such as Accelerated Graphics Port (AGP) and Industry Standard Architecture (ISA) may be used. Processor 302 and main memory 304 are connected to PCI local bus 306 through PCI bridge 308. PCI bridge 308 also may include an integrated memory controller and cache memory for processor 302. Additional connections to PCI local bus 306 may be made through direct component interconnection or through add-in boards. In the depicted example, LAN adapter 310, small computer system interface (SCSI) host bus adapter 312, and expansion bus interface 314 are connected to PCI local bus 306 by direct component connection. In contrast, audio adapter 316, graphics adapter 318, and audio/video adapter 319 are connected to PCI local bus 306 by add-in boards inserted into expansion slots. Expansion bus interface 314 provides a connection for a keyboard and mouse adapter 320, modem 322, and additional memory 324. SCSI host bus adapter 312 provides a connection for hard disk drive 326, tape drive 328, and compact disk-read-only-memory (CD-ROM) drive 330. Typical PCI local bus implementations will support three or four PCI expansion slots or add-in connectors.

An OS runs on processor 302 and is used to coordinate and provide control of various components within data processing system 300 in FIG. 3. The OS may be a commercially available OS, such as Windows® XP, which is available from Microsoft Corporation. An object oriented programming system such as JAVA® may run in conjunction with the operating system and provide calls to the operating system from JAVA® programs or applications executing on data processing system 300. JAVA® is a trademark of Sun Microsystems, Inc. Instructions for the OS, the object-oriented OS, and applications or programs are located on storage devices, such as hard disk drive 326, and may be loaded into main memory 304 for execution by processor 302.

Those of ordinary skill in the art will appreciate that the hardware in FIG. 3 may vary depending on the implementation. Other internal hardware or peripheral devices, such as flash ROM (or equivalent nonvolatile memory) or optical disk drives and the like, may be used in addition to or in place of the hardware depicted in FIG. 3. Also, the processes of the present invention may be applied to a multiprocessor data processing system.

As another example, data processing system 300 may be a stand-alone system configured to be bootable without relying on some type of network communication interface, whether or not data processing system 300 comprises some type of network communication interface. As a further example, data processing system 300 may be a Personal Digital Assistant (PDA) device, which is configured with ROM and/or flash ROM in order to provide non-volatile memory for storing OS files and/or user-generated data.

The depicted example in FIG. 3 and above-described examples are not meant to imply architectural limitations. For example, data processing system 300 may also be a notebook computer or hand held computer in addition to taking the form of a PDA. Data processing system 300 also may be a kiosk or a Web appliance.

The present invention provides a system, computer program product and method of enabling ISPs to synergistically identify and control SPAM e-mail. The invention may be local to client systems 108, 110 and 112 of FIG. 1 or to the server 104 or to both the server 104 and clients 108, 110 and 112. Further, the present invention may be embodied in a program product that may reside on any data storage medium (i.e., floppy disk, compact disk, hard disk, digital video disk (DVD), ROM, random access memory (RAM), magnetic tape etc.) used by a computer system.

Generally, a SPAM message may be identified at a mail gateway using an exclusionary/inclusionary filter (i.e., any one of the filters described previously) or by an end-user. A mail gateway is a machine that connects two or more e-mail systems together and may provide translation services where two or more dissimilar mail systems are interconnected.

According to the present invention, the graphical user interface (GUI) of an e-mail application will let an end-user alert a servicing mail gateway of a SPAM e-mail message. For example, the GUI may have a SPAM button, which when asserted while a message is either being displayed or selected, identifies the message as SPAM and sends the identified message to the servicing mail gateway.

When a SPAM e-mail message is identified (either automatically by the mail gateway or by an end-user who sends the SPAM e-mail message to the mail gateway), the mail gateway will send information regarding the identified SPAM e-mail message to a clearinghouse as an update to a SPAM database stored thereat. The mail gateway may provide the information to the clearinghouse by preferably connecting to a pre-defined port of the clearinghouse. Alternatively, the mail gateway may provide the information to the clearinghouse by sending an e-mail message to a predefined address. The information in this case includes the message source information, identity and text/data stream, which will henceforth be referred to as the SPAM message identification (id).

Once the SPAM database is updated, trusted ISPs will be alerted of the update. The trusted ISPs may take appropriate steps to ensure that the message does not continue to propagate. One of the steps that a trusted ISP may take includes deleting the e-mail message from its e-mail system or network. For example, incoming and outgoing e-mail messages at an ISP's mail gateway may be compared to the SPAM message id. If there is a match between the SPAM message id and an incoming or outgoing e-mail message id, then the incoming or outgoing e-mail message may be labeled as SPAM and deleted. The information of the deleted message (i.e., its SPAM message id), however, will also be provided to the clearinghouse. Here, the more information that is collected about a SPAM e-mail message, the greater the chance to identify its source (i.e., the original ISP of the spammer) so that the spammer may be banned.

Another step a trusted ISP may take includes banning the spammer from continuing to use the trusted ISP's e-mail services, either directly or as a conduit.

The trusted ISP may also label the ISP of the spammer as a SPAM ISP if the trusted ISP notifies the ISP of the spammer a number of times regarding the spammer's activity to no avail or if an inordinate number of spammers are using the services of the ISP. The trusted ISP may not allow e-mail messages that have the domain address of an ISP labeled as a SPAM ISP on its network. Further, the trusted ISP may notify other trusted ISPs of all ISPs labeled SPA ISPs.

The security of the SPAM database may be based on conventional public/private key pair security systems. In this case, the clearinghouse as well as each trusted ISP will have a public/private key pair. When the clearing house sends a message to the ISPs, the clearinghouse will use its private key to encrypt/authenticate the message. Likewise, the ISPs will use their private key to encrypt messages and authenticate themselves to the clearinghouse. This then ensures that only trusted ISPs have access to the SPAM database and foreclose spammers from manipulating the database to their advantage. Note that a committee may be used to determine who can be a trusted ISP.

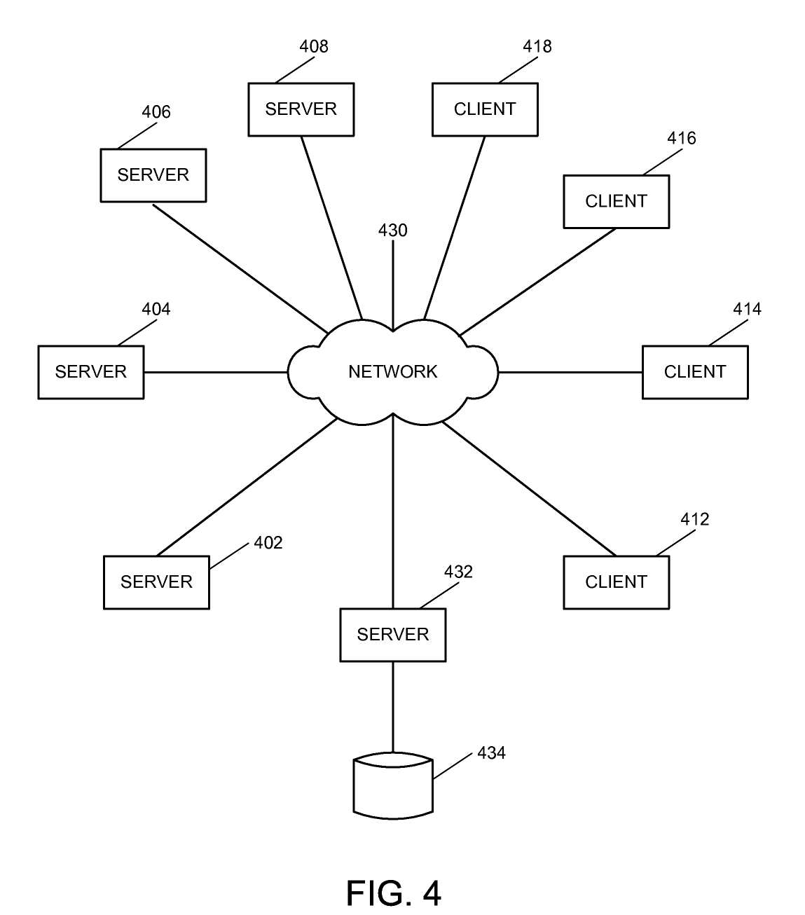

FIG. 4 is an exemplary mail system infrastructure. The mail system infrastructure includes mail servers 402, 404, 406 and 408, clients 412, 414, 416 and 418 and network 130. Each mail server can be for example a server 104 of FIG. 1. Each client can be any one of clients 108, 110 and 112 of FIG. 1 and network 130 may be the Internet, intranet or a combination thereof.

Suppose that server 432 is the clearinghouse and storage 434 contains the SPAM database. Suppose further that e-mail server 402 belongs to trusted ISPₐ, serves as a mail gateway and services clients 412 and 414 and mail server 404 belongs to trusted ISP_{b}, serves as a mail gateway and services clients 416 and 418. In addition, suppose a spammer using client 414 sends a SPAM e-mail message to a plurality of end-users including end-users on clients 412, 416 and 418 by channeling the SPAM e-mail message through either one or both of e-mail servers 406 and 408. Suppose furthermore that the e-mail message is first identified as SPAM by either the mail gateway of ISP_{b} (i.e., by mail server 404) or by an end-user being serviced by mail server 404 (i.e., either a user at client 416 or 418). According to the invention, upon identifying the message as SPAM, the mail gateway of ISP_{b} will preferably make contact with server 432 using a predefined port, authenticate itself and provide the SPAM e-mail id (i.e., the message source information, identity and text/data stream) to the clearinghouse.

ISP_{b} will also compare outgoing and incoming e-mail messages to determine if any one of them is a match to the SPAM e-mail message. Any message that turns out to be a match (i.e., same bit stream, a common message id and/or same sender) to the SPAM e-mail message will be flagged as SPAM. The mail gateway of ISP_{b} may scrutinize the header information of the flagged messages to determine whether it is the original ISP of the SPAM messages. In this case, ISP_{b} is not the original ISP and thus will delete the flagged messages and provide their SPAM e-mail id to the clearinghouse.

Upon receiving the initial SPAM e-mail id, the clearinghouse will update the database in storage 434 and alert trusted ISPₐ by providing the SPAM message id. ISPₐ will compare outgoing and incoming e-mail messages to determine if any one of them is a match to the SPAM e-mail message. Any message that identified as a match (i.e., same bit stream, a common message id and/or same sender) to the SPAM e-mail message will be flagged as SPAM. The mail gateway of ISPₐ may scrutinize the header information of the flagged messages to determine whether it is the original ISP of the SPAM messages. In this case, ISPₐ is the original ISP and through a combination of the header information of the different flagged messages may glean the identity of the sender. At that point ISPₐ may take proper actions against the sender (i.e., send warning notices, reminders of contract not to use ISPₐ's services to disseminate SPAM mail or banned the sender from using ISPₐ's services altogether). ISPₐ will also delete all flagged messages.

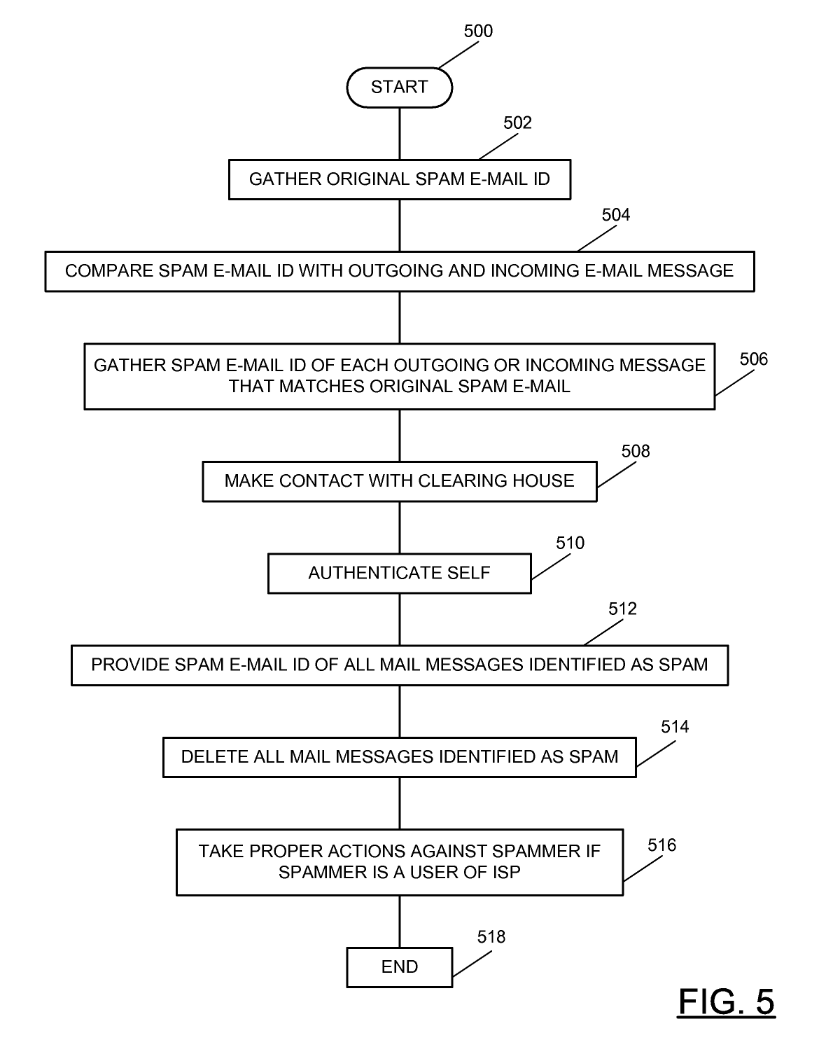

FIG. 5 is a flowchart of a process that may be used by a trusted ISP that identifies a SPAM e-mail message. As mentioned before, the SPAM e-mail message may originally be identified by a user that is being serviced by the ISP or by a mail gateway of the ISP. If the SPAM e-mail message is originally identified by a user, the user may send the SPAM e-mail message to the mail gateway by selecting or displaying the message and asserting a SPAM button or equivalent on the mail GUI used by the user. A SPAM e-mail message may originally be identified by a mail gateway using any one of the inclusionary/exclusionary filters, including Bayesian, Procmail etc. filters. In any case, when the message is identified by the mail gateway, an interrupt occurs and the process starts (step 500). The mail gateway then gathers SPAM e-mail id of the message identified as SPAM (step 502). Then, the mail gateway will compare the SPAM e-mail id with all incoming/outgoing e-mail messages to determine whether any one of the incoming/outgoing e-mail messages matches the SPAM e-mail id (step 504). If any one of the incoming/outgoing e-mail messages matches the SPAM e-mail id, it will be flagged as a SPAM e-mail message. The mail gateway will then gather SPAM e-mail id of all the messages flagged as SPAM (step 506), contact the clearinghouse (step 508), authenticate itself as a trusted ISP (step 510) and provide all gathered SPAM e-mail ids (step 512). The mail gateway will also delete all messages identified or flagged as SPAM (step 514) and take proper actions against any user (i.e., spammer) who sent the original SPAM e-mail message if the user is a customer of the ISP (step 516). After doing so, the mail gateway will get out of the interrupt and thus ends the process (step 518).

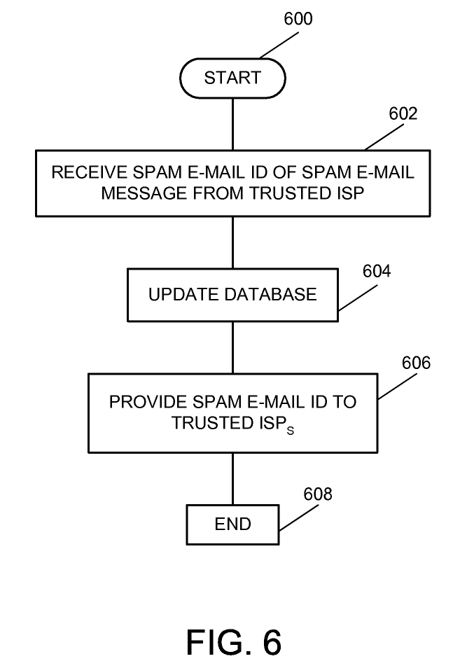

FIG. 6 is a flowchart of a process that may be used by a clearinghouse upon receiving a SPAM e-mail id of a SPAM e-mail message. After an ISP identifies itself as a trusted ISP, an interrupt will occur and the process will start (step 600). The clearinghouse will then receive the SPAM e-mail id(s) transferred by the trusted ISP (step 602). After receipt of the SPAM e-mail id(s), the clearinghouse will update the SPAM database (step 604) and alert all (other) trusted ISPs of the SPAM e-mail message by providing the SPAM e-mail id(s) to the trusted ISPs (step 606). After doing so, the clearinghouse will end the interrupt and the process will end (step 608).

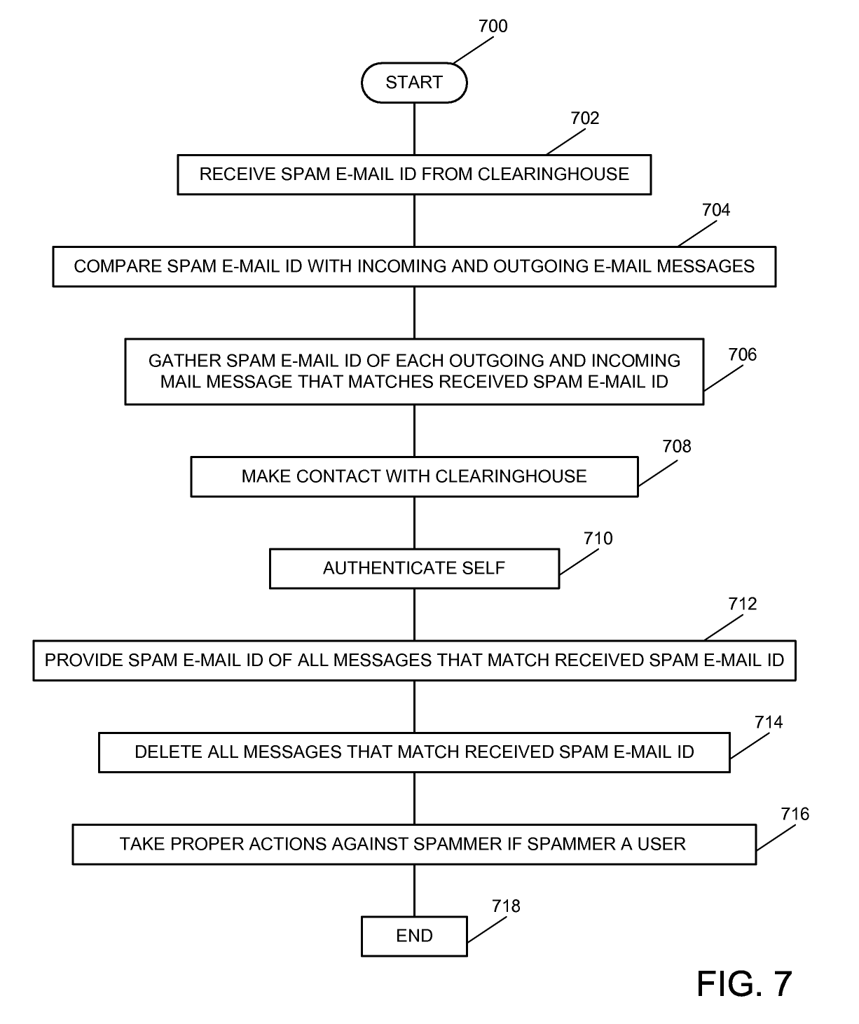

FIG. 7 is a flowchart of a process that may be used by a trusted ISP when receiving SPAM e-mail id(s) from the clearinghouse. When the clearinghouse authenticates itself after making contact with a trusted ISP, an interrupt will occur at the mail gateway of the trusted ISP and the process starts (step 700). The mail gateway of the trusted ISP will receive the SPAM e-mail id(s) from the clearinghouse (step 702). After receiving the SPAM e-mail id(s), the mail gateway will compare all incoming/outgoing e-mail messages with the received SPAM e-mail id(s) to determine if any one of them is a SPAM e-mail message (step 704). Any message that matches the SPAM e-mail message id will be flagged as SPAM and their SPAM e-mail id will be gathered (step 706) to be provided to the clearinghouse. As mentioned above, to provide the gathered SPAM e-mail id(s) to the clearinghouse, the trusted ISP has to make contact with the clearinghouse (step 708), authenticates itself as a trusted ISP (step 712) and then provide the gathered SPAM e-mail id(s) to the clearinghouse (step 712). After doing so, the trusted ISP will delete any message flagged as SPAM (step 714) and take proper actions against any user that originally sent the SPAM (step 716) and end the process by getting out of the interrupt (step 718).

The description of the present invention has been presented for purposes of illustration and description, and is not intended to be exhaustive or limited to the invention in the form disclosed. Many modifications and variations will be apparent to those of ordinary skill in the art. For example, the clearinghouse may be a trusted ISP etc. Thus, the embodiment was chosen and described in order to best explain the principles of the invention, the practical application and to enable others of ordinary skill in the art to understand the invention for various embodiments with various modifications as are suited to the particular use contemplated.

What is claimed is:

1. A method of enabling Internet service providers (ISPs) to synergistically identify and control SPAM electronic mail (e-mail) messages on a network comprising:
determining whether a received e-mail message is a SPAM e-mail message;
in response to determining that the received e-mail message is a SPAM e-mail message, transferring the received SPAM e-mail message to a database of SPAM e-mail messages;
enabling a plurality of ISPs to use the SPAM e-mail messages in the database to determine whether incoming and outgoing e-mail messages are SPAM e-mail messages; and
deleting the received SPAM e-mail message from the network.

2. The method of claim 1 wherein transferring the received SPAM e-mail message to a database of SPAM e-mail messages includes transferring source information, identity and data stream of the received SPAM e-mail message to the database.

3. The method of claim 2 wherein data stream of a SPAM e-mail message in the database is compared to data stream of an incoming or outgoing e-mail message to determine whether the incoming or outgoing e-mail message is a SPAM e-mail message.

4. The method of claim 3 wherein source information and identity of an incoming or outgoing e-mail message that is determined to be a SPAM e-mail message along with source information and identity of one or more SPAM e-mail messages in the database are used to determine a sender of the incoming or outgoing e-mail message.

5. The method of claim 4 wherein if the sender is a customer of one of the ISPs proper actions are taken by the one ISP to stop the sender from continuing to send SPAM email messages.

6. The method of claim 3 wherein when an incoming or outgoing e-mail is determined to be a SPAM e-mail, source information, identity and data stream of incoming or outgoing e-mail message are transferred to the database.

7. The method of claim 3 wherein when an incoming or outgoing e-mail is determined the incoming or outgoing e-mail message is deleted.

8. A computer program product on a computer readable medium, the computer program product including computer instructions which when executed by a processor enable Internet service providers (ISPs) to synergistically identify and control SPAM electronic mail (e-mail) messages on a network, the computer instructions comprising:
computer instructions for determining whether a received e-mail message is a SPAM e-mail message;
computer instructions, in response to determining that the received e-mail message is a SPAM e-mail message, for transferring the received SPAM e-mail message to a database of SPAM e-mail messages;
computer instructions for enabling a plurality of ISPs to use the SPAM e-mail messages in the database to determine whether incoming and outgoing e-mail messages are SPAM e-mail messages; and
computer instructions for deleting the received SPAM e-mail message from the network.

9. The computer program product of claim 8 wherein the transferring computer instructions include computer instructions for transferring source information, identity and data stream of the received SPAM e-mail message to the database.

10. The computer program product of claim 9 wherein data stream of a SPAM e-mail message in the database is compared to data stream of an incoming or outgoing e-mail message to determine whether the incoming or outgoing e-mail message is a SPAM e-mail message.

11. The computer program product of claim 10 wherein source information and identity of an incoming or outgoing e-mail message that is determined to be a SPAM e-mail message along with source information and identity of one or more SPAM e-mail messages in the database are used to determine a sender of the incoming or outgoing e-mail message.

12. The computer program product of claim 11 wherein if the sender is a customer of one of the ISPs proper actions are taken by the one ISP to stop the sender from continuing to send SPAM email messages.

13. The computer program product of claim 10 wherein when an incoming or outgoing e-mail is determined to be a SPAM e-mail, source information, identity and data stream of incoming or outgoing e-mail message are transferred to the database.

14. The computer program product of claim 10 wherein when an incoming or outgoing e-mail is determined the incoming or outgoing e-mail message is deleted.

15. A computer system for enabling Internet service providers (ISPs) to synergistically identify and control SPAM electronic mail (e-mail) messages on a network comprising:
at least one storage device for storing computer instructions; and
at least one processor for processing the computer instructions to determine whether a received e-mail message is a SPAM e-mail message, in response to determining that the received e-mail message is a SPAM e-mail message, to transfer the received SPAM e-mail message to a database of SPAM e-mail messages, to enable a plurality of ISPs to use the SPAM e-mail messages in the database to determine whether incoming and outgoing e-mail messages are SPAM e-mail messages, and to delete the received SPAM e-mail message from the network.

16. The computer system of claim 15 wherein the computer instructions are further processed to transfer source information, identity and data stream of the received SPAM e-mail message to the database.

17. The computer system of claim 16 wherein data stream of a SPAM e-mail message in the database is compared to data stream of an incoming or outgoing e-mail message to determine whether the incoming or outgoing e-mail message is a SPAM e-mail message.

18. The computer system of claim 17 wherein source information and identity of an incoming or outgoing e-mail message that is determined to be a SPAM e-mail message along with source information and identity of one or more SPAM e-mail messages in the database are used to determine a sender of the incoming or outgoing e-mail message.

19. The computer system of claim 18 wherein if the sender is a customer of one of the ISPs proper actions are taken by the one ISP to stop the sender from continuing to send SPAM email messages.

20. The computer system of claim 17 wherein when an incoming or outgoing e-mail is determined to be a SPAM e-mail, source information, identity and data stream of incoming or outgoing e-mail message are transferred to the database.
